(19) United States
(12) Patent Application Publication
(10) Pub. No.: US 2025/0390914 A1
(43) Pub. Date: Dec. 25, 2025

(54) SYSTEM AND METHOD FOR EFFICIENTLY AND ACCURATELY GENERATING A DIGITAL MEDIA PLAN

(71) Applicant: P39 Tech LLC, New York, NY (US)

(72) Inventors: Jonathan SCHLER, Petach Tikwa (IL); Alex WHITE, New Rochelle, NY (US)

(73) Assignee: P39 Tech LLC, New York, NY (US)

(21) Appl. No.: 18/753,702

(22) Filed: Jun. 25, 2024

(51) Int. Cl. G06Q 30/0251; G06Q 30/0241

(52) U.S. Cl. CPC G06Q 30/0257; G06Q 30/0276

(57) ABSTRACT

A system and method for generating a digital media plan. The method includes extracting advertisement features from an advertisement image; generating at least one prompt for a campaign dimension based on one or more of the extracted advertisement features; feeding the at least one prompt for each respective campaign dimension based on one or more extracted advertisement features to a target large language model; receiving responses to the prompts of the target large language models; and aggregating the answers to generate a digital media plan.

### TECHNICAL FIELD

The present disclosure relates generally to the field of artificial intelligence (AI) and machine learning and is applied to the generation and optimization of digital media plans.

### BACKGROUND

Artificial Intelligence (AI) marketing refers to the integration of artificial intelligence with marketing strategies and techniques. Large Language Models (LLMs) are a specific type of AI system designed to understand and generate human language. LLMs are a subset of AI that focuses on processing and generating natural language text. These models are trained on vast amounts of text data to learn the statistical patterns and structures of the human language. LLMs leverage deep learning architectures, such as transformers, to capture long-range dependencies and semantic relationships within text data. LLM technology is used for a variety of tasks, such as generating advertisements, advertisement campaigns, and digital media plans.

AI and LLM technologies face several technical challenges in accomplishing these marketing tasks. One primary issue is the generation of coherent and contextually relevant advertisements, advertisement campaigns, and digital media plans. While LLMs have made significant strides in natural language understanding and generation, ensuring that the generated advertisements effectively communicate the intended message while resonating with the target audience remains a complex task. Generating text that adheres to brand guidelines, incorporates marketing objectives, and aligns with the desired tone and style requires sophisticated language modeling techniques and fine-tuning of model parameters.

Another challenge is the optimization of LLM-generated advertisements and digital media plans for different platforms and mediums. Advertisements are often distributed across a variety of channels, including social media, websites, email campaigns, and mobile apps, each with its unique constraints and formatting requirements. Adapting the generated text to fit the constraints of different platforms while maintaining consistency and effectiveness presents a significant technical hurdle.

Furthermore, ensuring the scalability and efficiency of LLM advertisement and digital media plan generation is essential. As the demand for personalized and targeted advertising grows, the computational resources required to train and deploy LLMs at scale become increasingly significant. Optimized model architectures, training procedures, and inference pipelines minimize computational costs while maximizing performance is crucial for practical deployment in real-world advertising campaigns.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, method may include extracting advertisement features from an advertisement image. The method may also include generating at least one prompt for a campaign dimension based on one or more of the extracted advertisement features. Method may furthermore include feeding the at least one prompt for each respective campaign dimension based on one or more extracted advertisement features to a target large language model. The method may in addition include receiving responses to the prompts of the target large language models. Method may moreover include aggregating the answers to generate a digital media plan. Other embodiments of this aspect include corresponding computer systems, apparatus, and computer programs recorded on one or more computer storage devices, each configured to perform the actions of the methods.

In one general aspect, a non-transitory computer-readable medium may include one or more instructions that, when executed by one or more processors of a device, cause the device to: extract advertisement features from an advertisement image; generate at least one prompt for a campaign dimension based on one or more of the extracted advertisement features; feed the at least one prompt for each respective campaign dimension based on one or more extracted advertisement features to a target large language model; receive responses to the prompts of the target large language models; and aggregate the answers to generate a digital media plan. Other embodiments of this aspect include corresponding computer systems, apparatus, and computer programs recorded on one or more computer storage devices, each configured to perform the actions of the methods.

In one general aspect, a system may include one or more processors configured to: extract advertisement features from an advertisement image; generate at least one prompt for a campaign dimension based on one or more of the extracted advertisement features; feed the at least one prompt for each respective campaign dimension based on one or more extracted advertisement features to a target large language model; receive responses to the prompts of the target large language models; and aggregate the answers to generate a digital media plan.

Other embodiments of this aspect include corresponding computer systems, apparatus, and computer programs recorded on one or more computer storage devices, each configured to perform the actions of the methods.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram of a system utilized for generating a digital media plan, described in the disclosed embodiments.

FIG. 2 is a flowchart for a method of generating a digital media plan, according to an embodiment.

FIG. 3 is an illustration of an advertisement image, according to an embodiment.

FIG. 4 is a schematic diagram of a campaign generator, according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The disclosed embodiments include methods and systems for efficiently and accurately generating a digital media plan. In an embodiment, the system includes a campaign generator configured to extract advertisement features from an advertisement image, generate one or more prompts for each advertisement feature, feed the prompts to a target large language model (LLM), and receive answers for each prompt. Then, the campaign generator is configured to aggregate the answers to generate a digital media plan and display the digital media plan on a user device.

The disclosed embodiments improve the currently available AI marketing systems by improving the accuracy of advertisements, advertisement campaigns, and digital media plans. Moreover, the disclosed embodiments significantly increase the efficiency of the digital media planning process. Furthermore, the disclosed embodiments allow for the creation of advertisement campaigns in a quicker manner and allow for the creation of multiple campaigns in parallel. Further, the disclosed embodiments enable the creation of more fine-tuned campaigns.

The disclosed embodiments generate a digital media plan that includes automatic data-driven recommendations for the optimal selection of media channels, target audience, demographics, geographics, topic categories, search term targeting, placement recommendations, and the like. These data-driven recommendations allow for the generation of accurate advertisements and campaigns. Furthermore, the campaign generator automatically optimizes a campaign by monitoring the campaign's performance and adjusting target keywords and categories in real time to tailor the campaign to specific target audiences. Thus, further enhancing the accuracy and efficiency of these campaigns by enhancing engagement and relevance.

The disclosed embodiments streamline the digital media planning process by reducing the amount of time, manual effort, and resources needed from marketing professionals and their companies.

Technical improvements of the disclosed embodiments include the automation of digital data planning tasks to improve the efficiency of the data planning process to achieve more accurate advertisements and campaigns based on data-driven recommendations. In order to provide data-driven recommendations in the digital media plan the campaign generator processes a vast amount of data from the web, thus increasing system processing speed. The campaign generator can process vast amounts of data and perform data analysis at an incredible speed and accuracy far surpassing human capabilities.

Therefore, it should be understood that the operations described herein cannot be performed using the human mind or by performing the operation using paper and pencil. Moreover, a human operator applies subjective criteria to select/simulate/predict, leading to results that are not consistent between different human operators, and often not consistent between the same human performing the same task repeatedly, and in particular at the speeds required to provide an operable solution. The vast amount of data that needs to be mathematically analyzed and processed to provide data-driven recommendations for each unique digital media plan far exceeds any practical use of the human mind.

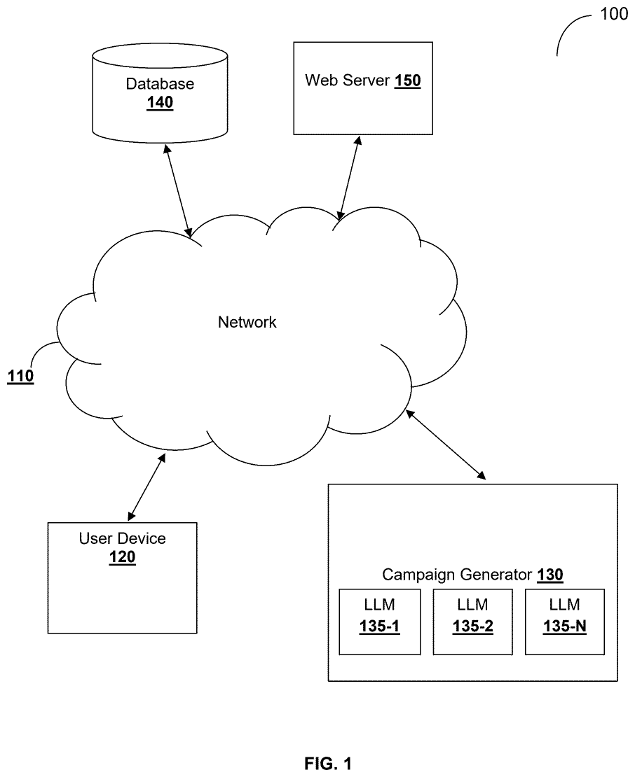

FIG. 1 shows an example network diagram 100 utilized to describe the various disclosed embodiments. In the example, a network diagram 100, a user device 120, a campaign generator 130, a database 140, and a web server 150, are communicatively connected via a network 110. A campaign generator 130 includes a plurality of Large Language Models (LLMs) 135-1 through 135-N (hereinafter referred to individually as an LLM 135 and collectively as LLMs 135, merely for simplicity purposes). In other embodiments, there may be a single or plurality of external LLMs 135 located outside of the campaign generator 130 system and accessed via a network 110.

The network 110 may be, but is not limited to, a wireless, cellular, or wired network, a local area network (LAN), a wide area network (WAN), a metro area network (MAN), the Internet, the world wide web (WWW), similar networks, and any combination thereof.

A user device (UD) 120 may be, but is not limited to, a personal computer, a laptop, a tablet computer, a smartphone, a wearable computing device, a device of a campaign manager, or any other device capable of receiving and displaying advertisement images and digital media campaigns. Other embodiments may include a web portal accessed by a user device 120. In certain embodiments, advertisement images are displayed by a user device 120 after a digital media campaign is generated.

In an embodiment, an advertisement image (hereinafter, an “ad image”) is an image illustrating one or more aspects of an advertisement, such as but not limited to, the brand name, product name, brand colors, brand logos, product description, picture of the product, product pricing, and slogan. Examples of ad images include but are not limited to a creative asset, a creative brief, and a media brief.

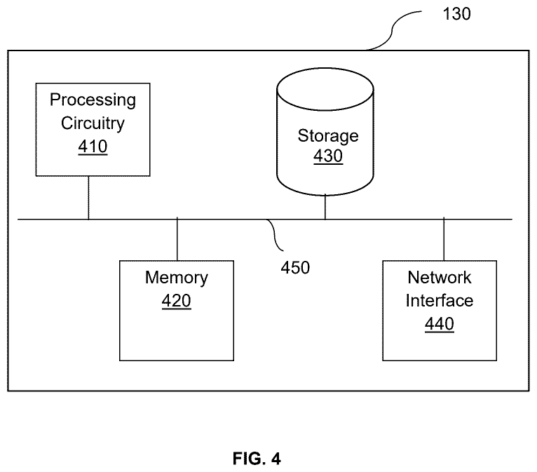

The campaign generator 130 may be realized as a physical machine or virtual machine executed in a cloud computing platform (or any other type of virtual assistant). An example block diagram of the campaign generator 130 is shown in FIG. 4.

An LLM 135 is a type of artificial intelligence (AI) system designed to understand, generate, and work with human language at a large scale. These models are trained on vast amounts of text and image data enabling them to perform a wide range of language and image processing-related tasks. Such tasks include answering queries, extracting textual data from images, generating responses based on web data, and even classifying images and text based on various criteria. An LLM 135 may include, for example, T5, Generative Pre-trained Transformer (GPT) 3, Generative Pre-trained Transformer (GPT) 4, Claude, DALL-E, DALL-E 2, DALL-E 3, and the like. The LLMs 135 may be trained on specific datasets in order to carry out the disclosed embodiments. For example, LLM 135 may be trained or fine-tuned based on datasets related to past events of a specific brand or a similar brand.

A web server 150 is computer software and underlying hardware that uses Hypertext Transfer Protocol (HTTP) and other protocols to respond to user requests made over the World Wide Web. The web server 150 is configured to display website content for storing, processing, and delivering ad images, social media platforms, e-commerce websites, and other subject matter such as news, sports, and the like to users. Another embodiment of a web server 150 includes a search plugin or any other device that provides the ability to access a search engine from a web browser. Digital media or a creative that is part of the campaign is served on a web page or a web application hosted by web server 150.

A database of 140 stores ad images, including features (hereinafter “ad features”) of the image. Such ad features include, but are not limited to color data, textual data, and object data. Color data is any color or color scheme in an ad image. Textual data includes any text in an ad image, such as but not limited to slogans, logos, product names, numerals, pricing, branding, font type, font size, font color, text location, and the like. Object data includes any defined shape or figure within an ad image. For example, object data includes a picture of the product, human models, animated characters, and the like. Also, the database 140 stores the digital media plan including data-driven campaign recommendations generated from the campaign generator 130.

According to the disclosed embodiment, the user device 120 receives an ad image from a user. The ad image includes ad features that are utilized to generate a digital media plan. A campaign dimension is a specific aspect or element of an advertisement campaign that impacts the success of the campaign (e.g. target audience, media channels, trends in the market, content, and the like.) A user of a user device 120 uploads an ad image to the campaign generator 130. The campaign generator 130 is configured to extract ad features from the ad image, such as but not limited to color data, textual data, and object data. Further examples include brand colors, logos, slogans, product images, and the like. The campaign generator 130 is configured to generate a concise prompt and feed the prompt and/or an ad image to an LLM 135. In an embodiment, the campaign generator 130 generates a single prompt or a plurality of different prompts and feeds them to a single LLM 135. In another embodiment, the campaign generator 130 generates a single prompt or a plurality of different prompts and feeds the generated prompts to a plurality of different LLMs 135. In certain embodiments, the campaign generator 130 decides which prompt should be fed to which LLM 135 of a plurality of LLMs 135 based on the type of ad feature associated with the prompt and the content of the prompt. Furthermore, an LLM is determined by whether the prompt requires text and/or image input and whether the prompt requires text and/or image output. In another embodiment, the campaign generator 130 determines which prompt should be fed to which LLM 135 based on additional machine learning methods and/or gained performance metrics of LLMs 135 over a period of time. It should be noted that FIG. 1 depicts an implementation of various disclosed embodiments, but that at least some disclosed embodiments are not necessarily limited as such. Other deployments, arrangements, combinations, and the like, may be equally utilized without departing from the scope of the disclosure. A prompt is any request or query, the campaign generator 130 requires generating and optimizing a digital media plan. An example of a prompt is, “provide a list of competing products”. In some embodiments, prompts may be cascaded, meaning that responses to certain prompts may be integrated into a subsequent prompt and fed to an LLM 135 as a following request.

The LLM 135 sends the answer to the prompt to a campaign generator 130. The campaign generator 130 uses the answer to generate a digital media plan. A digital media plan is a comprehensive guide that outlines how to efficiently utilize digital platforms and media channels to achieve an overall advertising strategy. In an embodiment, the digital media plan includes automatic data-driven recommendations; for a selection of digital platforms, media channels, target audiences, target categories, demographics, geographics, placement recommendations, and the like. Moreover, the digital media plan may create customized keyword categories, search terms targeted to an ad image, or any other content-based targeting method.

The particular configuration depicted in FIG. 1 is an example only. For example, while each of the elements is represented as separate in FIG. 1, in some embodiments, one or more of the elements may be implemented using the same hardware, software, virtual machine, or the like. Furthermore, while each of the elements is represented as a single entity in FIG. 1, in some embodiments, each such system may include one or more entities. For example, multiple campaign generators 130 can be utilized.

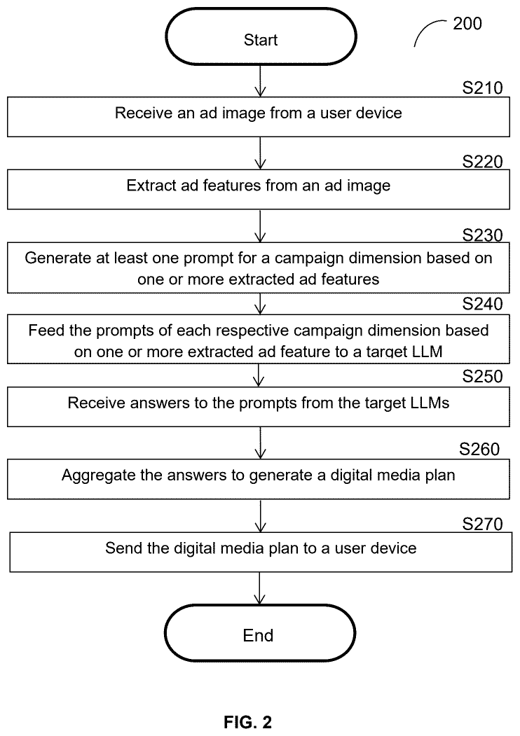

FIG. 2 is an example flowchart 200 of a method for generating a digital media plan, according to an embodiment. The method, in an embodiment, is performed by the campaign generator (FIG. 1, 130).

At S210, an ad image from a user device is received. An ad image may also be obtained from a database (FIG. 1, 140). An ad image illustrates one or more aspects of an advertisement, such as but not limited to, the brand name, product name, brand colors, brand logos, product description, picture of the product, product pricing, and slogan. Examples of ad images include but are not limited to a creative asset, a creative brief, and a media brief. The user device (FIG. 1, 120) uploads an ad image to a campaign generator (FIG. 1, 13) via the cloud, internet, network, and the like.

At S220, ad features are extracted from an ad image. Ad features such as color data, textual data, and object data, are extracted. These features may be extracted by using image processing techniques such as convolutional neural networks (CNN), scale-invariant feature transform (SIFT), Histogram of Oriented Gradients (HOG), speeded-up robust features (SURF), calculating mean pixel values, edge detection, and the like. Furthermore, ad features may be extracted by image recognition techniques, training a machine learning model to extract the features, and querying large language models (e.g. also using a prompt). In certain embodiments, an LLM 135 or a plurality of LLMs 135 may be used to extract ad features of an ad image (e.g. creative asset, creative brief, media brief, etc.), examples of such LLMs include DALL-E and Generative Pre-trained Transformer (GPT4).

Convolutional neural networks use convolution layers to extract features and/or textual data from an image. Convolution layers apply filters to image data to capture distinct visual characteristics like edges, textures, text, and shapes. SIFT is an algorithm that extracts features from images based on detecting key points and extracting local feature descriptors that capture the local image information around those key points. HOG is an algorithm that extracts spatial features to identify objects within an image by using information about image gradients. SURF is an enhanced version of SIFT and provides a faster and more efficient feature extraction process. It uses a Hessian matrix-based approach for keypoint detection and generates a descriptor for each key point by computing Haar wavelet responses for each square region around a key point.

At S230, at least one prompt is generated for a campaign dimension based on one or more extracted ad features. A prompt is any request or query, that provides information to generate and optimize a digital media plan. A campaign dimension is a specific aspect or element of an advertisement campaign that impacts the success of the campaign (e.g. target audience, media channels, trends in the market, content, and the like.) Ad features include but are not limited to color data, textual data, and object data. In an embodiment, a prompt is generated based on a dimension and one or more ad features. For example, if an ad image contains text describing the features of the product, a corresponding prompt pertaining to the dimension of product competition may be generated. An example of such a prompt would be, “provide a list of related items to the described service in the image.” In other embodiments, prompts may be generated based on only dimensions and not extracted ad features.

At S240, prompts of each respective campaign dimension based on one or more extracted ad features are fed to a target LLM. An LLM (FIG. 1, 135) is an AI system that is trained on vast amounts of text and image data. Depending on the type of LLM (FIG. 1, 135), the LLM may accept as input either text and/or an image. Also depending on the type of LLM (FIG. 1, 135), the LLM may output text and/or an image. A target LLM (FIG. 1, 135), is assigned to a specific prompt if the LLM (FIG. 1, 135) corresponds to the content of the prompt and accepts the required input from the prompt. The required input may be text input and/or an image. The target LLM (FIG. 1, 135) is also assigned if it is able to provide the desired output to the prompt. The desired output may be in text or an image.

For example, if a prompt states, “What is the text tagline best representing of this image?”, the assigned target LLM will be Claude, as it accepts images as input and returns text as output. The campaign dimension may include a “tagline” applied on an ad feature “image.” In response to the prompt, Claude will return an arrangement of the text in the image as an answer. In another example, if a prompt states, “provide a list of related items to the described service in the advertisement”, the assigned target LLM will be GPT 4 because it parses both image and text input. In response to the prompt, GPT 4 will return a list of relevant names of items.

At S250, answers to the prompts from the target LLMs are received. For example, if the prompt states, “provide a list of competing products”, an LLM (FIG. 1, 135) will return a list of names of the competing products. In some embodiments, there will be several iterations of answers to prompts which may be directed towards the digital media plan. Furthermore, additional information based on previous answers to prompts may be generated. As noted above, in certain embodiments, prompts may be cascaded.

At S260, the answers are aggregated to generate a digital media plan. The generated answers from each prompt are collected and compiled to generate the digital media plan. A digital media plan is a comprehensive guide that outlines how to efficiently utilize digital platforms and media channels to achieve an overall advertising strategy. In an embodiment, the digital media plan includes automatic data-driven recommendations; for a selection of digital platforms, media channels, target audiences, target categories, demographics, geographics, placement recommendations, and the like. Moreover, the digital media plan may create customized keyword categories, search terms targeted to an ad image, or any other content-based targeting method.

At S270, the digital media plan is sent to a user device (e.g. device of a campaign manager). A user device (FIG. 1, 120) displays the digital media plan to a user. A user device (FIG. 1, 120) may be, but is not limited to, a personal computer, a laptop, a tablet computer, a smartphone, a wearable computing device, a device of a campaign manager, or any other device capable of receiving and displaying advertisement images and digital media campaigns. Other embodiments may include a web portal accessed by a user device (FIG. 1, 120).

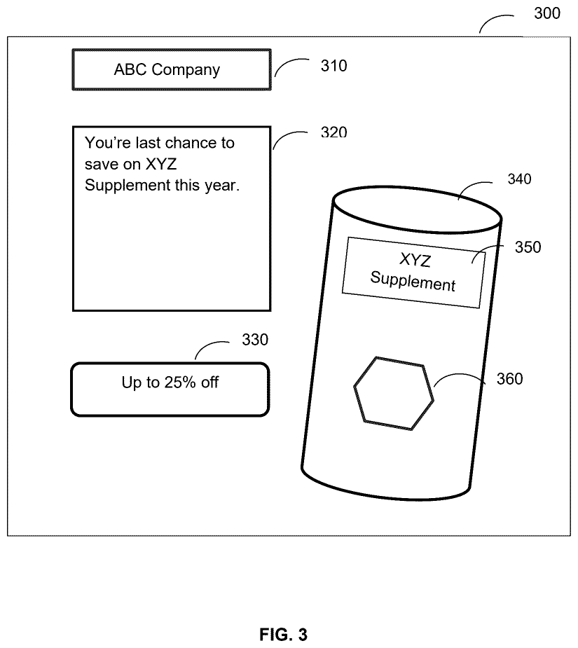

FIG. 3. is an example illustration of an advertisement image 300, according to an embodiment. An ad image is an image illustrating one or more aspects of an advertisement, such as but not limited to, the brand name, product name, brand colors, brand logos, product description, picture of the product, product pricing, and slogan. In an embodiment, the ad image 300 includes ad features such as textual data including the company name 310, promotional text 320, pricing information 330, and the product name 350. The ad image 300 also includes object data including the product image 340 and the brand logo 360.

In an embodiment, a campaign generator (FIG. 1, 130) may receive an ad image from a user device (FIG. 1, 120) or obtain an ad image from a database (FIG. 1, 140). A campaign generator (FIG. 1, 130) extracts each ad feature from an ad image 300 including the company name 310, promotional text 320, pricing information 330, the product image 340, and the brand logo 360. These ad features may be extracted by using LLMs 135 or image processing techniques such as those discussed above.

In an embodiment, a campaign generator (FIG. 1, 130) will generate at least one prompt for a campaign dimension based on one or more extracted ad features. A dimension is a specific aspect or element of an advertisement campaign that impacts the success of the campaign (e.g. target audience, media channels, trends in the market, content, and the like.) For example, for the ad feature of the company name 310, and the dimension of market competition the prompt, “provide a list of competing companies in the industry”, will be generated. In another example, for the textual data in the ad image (e.g. company name 310, promotional text 320, pricing information 330, and product name 350), the prompt, “build a key phrase classifier for this ad,” will be generated.

Each of the generated prompts for each dimension based on one or more extracted ad features will be fed to a target LLM of a plurality of LLMs (FIG. 1. 135). A target LLM (FIG. 1, 135), is assigned to a prompt depending on the type of ad feature associated with the prompt and the content of the prompt. Furthermore, a target LLM is determined by whether the prompt requires text and/or image input and whether the prompt requires text and/or image output. In certain embodiments, prompts may be generated based on dimensions and not extracted ad features. In some embodiments, prompts are cascaded, meaning that responses to certain prompts may be integrated into a subsequent prompt and fed to an LLM as a following request.

For example, for the prompt, “Build a key phrase-based classifier for this ad”, the assigned target LLM (FIG. 1, 135) will be GPT4 because it parses both image and text input and outputs text. In response to the prompt, GPT4 will generate a key phrase classifier that assigns a document as being relevant to the advertisement of an ad image, if one or more key phrases are present in the document. Then GPT4 will generate the fifty most popular and significant key phrases that if they are present in the document, it means that the document is relevant to the text of the image. The key phrases may contain product names, brand names, related items, and the like.

In another example, for the prompt, “What would be the relevant interactive advertising bureau (IAB) categories for this ad?”, Claude will be assigned as the target LLM (FIG. 1, 135) because it accepts images as input and may output text. In response to the prompt Claude will provide a list of IAB category names as they appear on the IAB taxonomy.

In an embodiment, the campaign generator (FIG. 1, 135) will receive the plurality of answers generated from various LLMs (FIG. 1, 135). The campaign generator will aggregate each of these answers by compiling them and arranging them in an optimized format to generate a digital media plan. A digital media plan is a comprehensive guide that outlines how to efficiently utilize digital platforms and media channels to achieve an overall advertising strategy. Once the digital media plan is generated it is sent by the campaign generator (FIG. 1, 130) to the user device (FIG. 1, 120) to be displayed for the user.

Once an advertisement campaign is developed based on the generated digital media plan, the campaign generator (FIG. 1, 135) automatically optimizes the advertisement campaign by monitoring its performance and adjusting targeting keywords or categories in real time. In an embodiment, the campaign generator (FIG. 1, 135) initially optimizes the advertisement campaign before it goes live. Such optimization may be based on past advertisement data. Additionally, the campaign generator (FIG. 1, 135) provides ongoing improvements to the advertisement campaign based on real-time performance data. The campaign generator (FIG. 1, 135) identifies high-performing pages from an advertisement campaign and analyzes them to identify unique characteristics of the pages, such as unique content keywords and content categories. Then, the campaign generator gives more weight to those elements and automatically adjusts keywords and categories in underperforming pages to align them with the unique characteristics of the high-performing pages. This optimizes the performance of the overall advertisement campaign by increasing engagement and relevancy. Furthermore, the campaign generator (FIG. 1, 130) uses the unique characteristics from the high-performing pages (e.g., unique keywords, content categories, etc.) to train LLMs (FIG. 1, 135) and optimize generated prompts for refined future targeting recommendations.

FIG. 4 is an example schematic diagram of a campaign generator 130 according to an embodiment. The campaign generator 130 includes a processing circuitry 410 coupled to a memory 420, a storage 430, and a network interface 440. In an embodiment, the components of the campaign generator 130 may be communicatively connected via a bus 450. The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 420 may be volatile (e.g., random access memory, etc.), non-volatile (e.g., read-only memory, flash memory, etc.), or a combination thereof.

In one configuration, software for implementing one or more embodiments disclosed herein may be stored in the storage 430. In another configuration, the memory 420 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 410, cause the processing circuitry 410 to perform the various processes described herein.

The storage 430 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 440 allows the campaign generator 130 to communicate with, for example, the database (FIG. 1, 140), user device 120, and web server 150.

It should be understood that the embodiments described herein are not limited to the specific architecture illustrated in FIG. 4, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

1. A method for generating a digital media plan, comprising:
extracting advertisement features from an advertisement image;
generating at least one prompt for a campaign dimension for querying a target large language model based on one or more of the extracted advertisement features;
assigning the target large language model from a plurality of large language models to each prompt of the generated at least one prompt, wherein the assigned target large language model corresponds to content and input type of the each prompt of the generated at least one prompt;
feeding the at least one prompt for the campaign dimension based on one or more extracted advertisement features to the respectively assigned target large language model;
receiving output responses to the at least one prompt of the target large language model; and
aggregating the output responses for a plurality of campaign dimension to generate a digital media plan.

2. The method of claim 1, wherein the digital media plan is a comprehensive guide that outlines how to utilize digital platforms and media channels to achieve an overall advertising strategy.

3. The method of claim 1, wherein the digital media plan includes data-driven recommendations for at least one of: a selection of digital platforms, media channels, target audiences, target categories, demographics, and geographics.

4. (canceled)

5. The method of claim 1, further comprising:
determining which prompt should be fed to which target large language model out of a plurality of large language models based on whether the prompt includes text or image input and whether the prompt requires text or image output.

6. The method of claim 1, further comprising:
cascading prompts by integrating certain prompt responses into a subsequent prompt and feeding the subsequent prompt to a large language model as a following request.

7. The method of claim 1, wherein advertisement features include at least one of:
color data, textual data, and object data.

8. The method of claim 1, further comprising:
extracting advertisement features by applying a large language model.

9. The method of claim 7, further comprising:
extracting textual data of advertisement features by using large language models.

10. A non-transitory computer-readable medium storing a set of instructions for generating a digital media plan, the set of instructions comprising:
one or more instructions that, when executed by one or more processors of a device, cause the device to:
extract advertisement features from an advertisement image;
generate at least one prompt for a campaign dimension for querying a target large language model based on one or more of the extracted advertisement features;
assign the target large language model from a plurality of large language models to each prompt of the generated at least one prompt, wherein the assigned target large language model corresponds to content and input type of the each prompt of the generated at least one prompt;
feed the at least one prompt for the campaign dimension based on one or more extracted advertisement features to the respectively assigned target large language model;
receive output responses to the at least one prompt of the target large language model; and
aggregate the output responses for a plurality of campaign dimensions to generate a digital media plan.

11. A system for generating a digital media plan comprising:
one or more processors configured to:
extract advertisement features from an advertisement image;
generate at least one prompt for a campaign dimension for querying a target large language model based on one or more of the extracted advertisement features;
assigning the target large language model from a plurality of large language models to each prompt of the generated at least one prompt, wherein the assigned target large language model corresponds to content and input type of the each prompt of the generated at least one prompt;
feed the at least one prompt for the campaign dimension based on one or more extracted advertisement features to the respectively assigned target large language model;
receive output responses to the at least one prompt of the target large language model; and
aggregate the output responses for a plurality of campaign dimension to generate a digital media plan.

12. The system of claim 11, wherein the digital media plan is a comprehensive guide that outlines how to utilize digital platforms and media channels to achieve an overall advertising strategy.

13. The system of claim 11, wherein the digital media plan includes data-driven recommendations for at least one of:
a selection of digital platforms, media channels, target audiences, target categories, demographics, and geographics.

14. (canceled)

15. The system of claim 11, wherein the one or more processors are further configured to:
determine which prompt should be fed to which target large language model out of a plurality of large language models based on whether the prompt includes text or image input and whether the prompt requires text or image output.

16. The system of claim 11, wherein the one or more processors are further configured to:
cascade prompts by integrating certain prompt responses into a subsequent prompt and feeding the subsequent prompt to a large language model as a following request.

17. The system of claim 11, wherein advertisement features include at least one of:
color data, textual data, and object data.

18. The system of claim 17, wherein the one or more processors are further configured to:
extract textual data of advertisement features by using large language models.

19. The system of claim 11, wherein the one or more processors are further configured to:
extract advertisement features by applying a large language model.
